(19) United States
(12) Patent Application Publication
(10) Pub. No.: US 2020/0250353 A1
(43) Pub. Date: Aug. 6, 2020

(54) SYSTEM FOR MANAGING BUILDINGS

(71) Applicant: AJINOMOTO ENGINEERING CORPORATION, Tokyo (JP)

(72) Inventors: Takayuki KOBAYASHI, Kawasaki-shi (JP); Fumihiro KOBAYASHI, Kawasaki-shi (JP)

(21) Appl. No.: 16/776,550

(22) Filed: Jan. 30, 2020

(30) Foreign Application Priority Data
Jan. 31, 2019 (JP) 2019-015690

(51) Int. Cl. G06F 30/13; G06F 30/12; G06F 3/0482; G06F 3/0481; G06F 3/0484; G06F 3/0486

(52) U.S. Cl. CPC G06F 30/13; G06F 30/12; G06F 3/0482; G06F 2111/02; G06F 3/04845; G06F 3/0486; G06F 3/04815

(57) ABSTRACT

To shorten an amount of time for a series of operations including design of a facility or a piping arrangement, order placement to a contractor, and estimation work by a contractor, while reducing operation mistakes. A system includes: means for drawing a facility or a piping arrangement of a building on a design drawing, means for outputting point group data and 3D design information from the design drawing, means for outputting the point group data from the design drawing as well as types and a quantity of parts from the 3D design information, means for displaying the types and the quantity of the parts and displaying a work item necessary for construction, means for prompting input of data with respect to a unit price for each type of the parts and input of data with respect to a unit price and workload required for the work item and transmitting inputted data to a server, means for calculating an estimated cost based on data obtained from the input means, means for presenting the estimated costs transmitted from the plurality of contractor side terminals to the contractee side terminal, means for selecting any one of the estimated costs, and means for transmitting a selected result to the plurality of contractor side terminals.

### BACKGROUND OF THE INVENTION

### Field of the Invention

The present invention relates to a system for managing buildings.

### Description of Related Art

When a building such as a facility and a piping arrangement is newly built or added within the premises of a factory or the like, new designing, price estimation, and order placement thereof are required. Furthermore, maintenance thereafter is also required.

JP-A-2009-145983 (Japanese Patent No. 5001811) is one of the examples in this field, which was developed as means for making an approximate estimate. For example, when a building is built, an additional order or request is submitted by a customer as it arises. The means disclosed in JP-A-2009-145983 (Japanese Patent No. 5001811) can present approximate cost to be generated for such a demand.

In the current construction industry, the existence of a multistoried subcontract structure has been pointed out. Factors in the growth of the multistoried subcontract structure include deepening specialization and division of labor due to sophistication of the contents of construction production and the like. In addition, the structure serves not only as a measure against increase or decrease of a volume of business as well as a measure against an occurrence of business fluctuation, both of which are the characteristics of the order receiving industry, but also as a way to reduce cost through outsourcing. The multistoried subcontract structure produces problems such as decreased productivity and a negative impact on labor cost due to increase in overhead expenses, less clarified responsibility for construction and the resulting quality loss, and safety deterioration caused by insufficient safety instructions. As a result, it leads to heavier cost burden on the contractee side. As one of the countermeasures against this, there is a need for a system that enables a contractee to properly manage a plurality of contractors that constitute the multistoried subcontract structure.

### BRIEF SUMMARY OF THE INVENTION

An object of the present invention is to shorten an amount of time for a series of operations including design of a facility or a piping arrangement, order placement to a (building) contractor, and estimation work by the contractor, while reducing operation mistakes.

Another object of the present invention is to facilitate a maintenance work of a facility or a piping arrangement after construction.

Yet another object of the present invention is to properly manage a plurality of building contractors.

A system in which a contractee side terminal, a server, and a plurality of (building) contractor side terminals are connected through a network, the system including:

means, in the contractee side terminal, for drawing a facility or a piping arrangement of a building on a design drawing,

means, in the contractee side terminal, for outputting point group data and 3D design information from the design drawing,

means, in the server, for outputting the point group data from the design drawing as well as types and a quantity of parts from the 3D design information,

means, in each of the plurality of contractor side terminals, for displaying the types and the quantity of the parts and to display a work item necessary for construction,

means, in each of the plurality of contractor side terminals, for prompting input of data with respect to a unit price for each type of the parts and input of data with respect to a unit price and workload required for the work item and transmitting inputted data to the server,

means, in the server, for calculating an estimated cost based on data obtained from the input means,

means, in the server, for present the estimated costs transmitted from the plurality of contractor side terminals to the contractee side terminal,

means, in the contractee side terminal, for selecting any one of the estimated costs, and

means, in the server, for transmitting a selected result to the plurality of contractor side terminals.

According to one aspect of the present invention, an amount of time for a series of operations from a site investigation, designing, estimate specification creation, contractor estimate format creation, to comparison table creation after contractor estimation can be shortened. For example, the site investigation can be omitted to shorten shutdown duration at a factory. Furthermore, work efficiency is improved as operation mistakes involved with estimation work can be reduced. In addition, as a contractee takes the initiative in managing building contractors effectively, the multistoried subcontract structure will be further corrected, resulting in a possibility of increased productivity of the entire construction industry.

Other objects, characteristics, and advantages of the invention will become apparent from the following description of the embodiments of the present invention with respect to the accompanying drawings.

### BRIEF DESCRIPTION OF THE SEVERAL VIEWS OF THE DRAWING

FIG. 1 is an example of a configuration of a system according to one embodiment of the invention;

FIG. 2 is an example of information processing in the system according to one embodiment of the invention;

FIG. 3A is an example of information processing in the system according to one embodiment of the invention;

FIG. 3B is an example of information processing in the system according to one embodiment of the invention;

FIG. 4 is an example of a data structure used in the system according to one embodiment of the invention;

FIG. 5 is an example of a work drawing displayed on a display screen of the system according to one embodiment of the invention;

FIG. 6 is an example of information processing in the system according to one embodiment of the invention;

FIG. 7 is an example of estimate comparison in the system according to one embodiment of the invention; and

FIG. 8 is an example of information processing with respect to a maintenance management service combined with a production management service in the system according to one embodiment of the invention.

### DETAILED DESCRIPTION OF THE INVENTION

An embodiment of the present invention will be described with reference to the drawings.

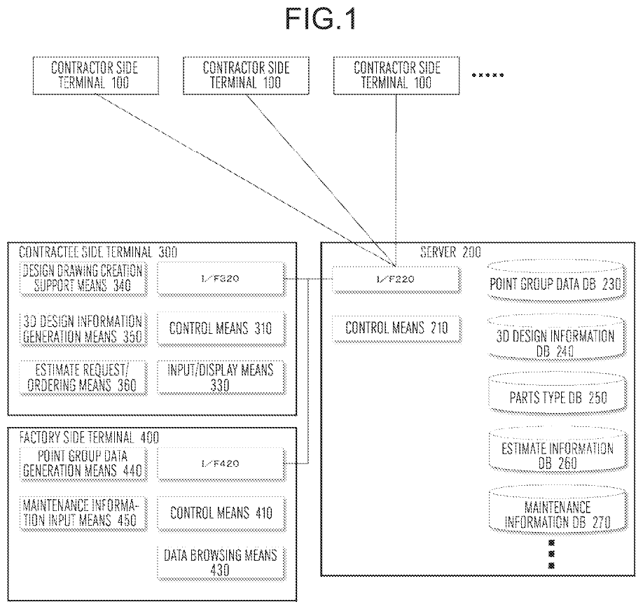

FIG. 1 is an example of a system according to one embodiment of the present invention.

A plurality of contractor side terminals 100, a server 200, a contractee side terminal 300, and a factory side terminal 400 are connected through a network 500 (not illustrated).

The contractor side terminal 100 is typically installed for each contractor that carries out construction work.

The server 200 can provide service to the plurality of contractor side terminals 100, the contractee side terminal 300, and the factory side terminal 400.

The contractee side terminal 300, which can input and output data to other terminals, is installed where various kinds of design and contractor selection for carrying out construction and maintenance are performed.

The factory side terminal 400, which can input and output data to other terminals, is installed in a factory to which construction and maintenance is carried out.

The network 500, which can connect the plurality of contractor side terminals 100, the server 200, the contractee side terminal 300, and the factory side terminal 400 by electrical or other means, may be the so-called wired and/or wireless Internet or may be a dedicated private line.

One example of a structure of the server 200 will be described.

The server 200 consists of control means 210, an interface (I/F) 220, a point group data DB 230, a 3D design information DB 240, a part type DB 250, an estimate information DB 260, and a maintenance information DB 270.

Control means 210 can control the respective means in a server and access a database (DB) directly or indirectly.

The interface (I/F) 220 can communicate with other terminals and the like.

The point group data DB 230 can store point group data.

The 3D design information DB 240 can store 3D design information.

The part type DB 250 can store part type information.

The estimate information DB 260 can store an estimated cost and a contractor who has submitted an estimate.

The maintenance information DB 270 can store maintenance information.

One example of a structure of the contractee side terminal 300 will be described.

The contractee side terminal 300 consists of control means 310, an I/F 320, input/display means 330, design drawing creation support means 340, 3D design information generation means 350, and estimate request/ordering means 360.

The control means 310 can control the respective means in the contractee side terminal and access a database (DB) directly or indirectly.

The interface (I/F) 320 can communicate with other terminals and the like.

The input/display means 330 can input necessary information and display a design drawing.

The design drawing creation support means 340 can support creation of a design drawing.

The 3D design information generation means 350 can generate 3D design information.

The estimate request/ordering means 360 can request a contractor side terminal of a contractor who wishes to undertake construction or the like to submit an estimate, and select a final ordering destination out of the plurality of contractors.

One example of a structure of the factory side terminal 400 will be described.

The factory side terminal 400 consists of control means 410, an I/F 420, data browsing means 430, point group data generation means 440, and maintenance information input

means 450.

The control means 410 can control the respective means in the factory side terminal and access a database (DB) directly or indirectly.

The interface (I/F) 420 can communicate with other terminals and the like.

The data browsing means 430 can display point group data and the like so that a user is allowed to browse it.

The point group data generation means 440 can perform a 3D scanning in a factory by using a 3D scanner and the like and generate point group data from the scanned data.

The maintenance information input means 450 can input maintenance information.

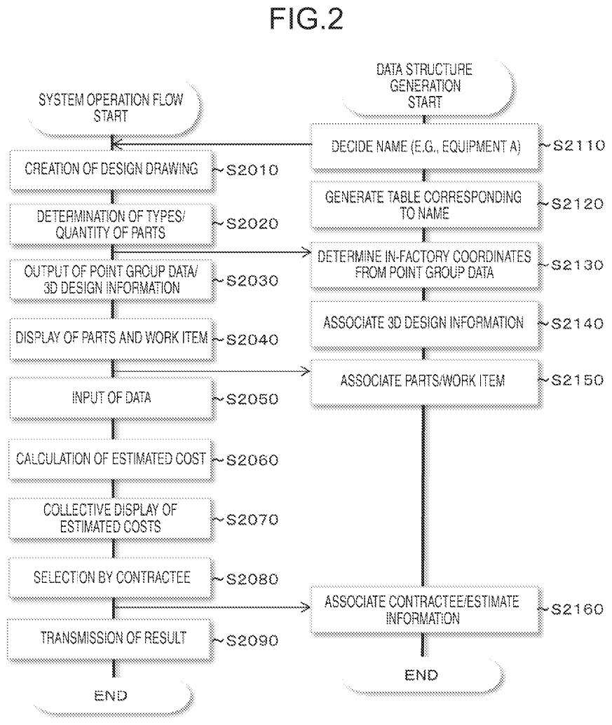

FIG. 2 is an example of information processing in the system according to one embodiment of the present invention. Particularly, FIG. 2 shows a flowchart of information processing of the entire system according to the embodiment (on the left side of FIG. 2) and a flowchart of information disclosure that generates a data structure as shown in FIG. 4 (on the right side of FIG. 2), including an association between the two flowcharts.

In this embodiment, the system processes data of a series of operations from 3D design, price estimation, to order placement. First, the flowchart of information processing of the entire system according to the embodiment will be described.

In S2010, the contractee side terminal draws a facility or a piping arrangement of a building on a design drawing or on point group data.

In S2020, the server generates information necessary to create an estimate such as types and a quantity of parts, a content with respect to labor cost (for example, a content of a part installation work) from the point group data and the 3D design information. In this regard, the types and the quantity of the parts and the content of the labor cost are respectively attached with one or more tags. For example, if a part is outputted, the part is attached with a tag that shows that it is a part used in “a first process”, and is also attached with a tag that shows it is a “part”. Furthermore, if there is a process that generates labor cost, a tag is attached for each process (for example, “a first process” or “a second process”) with another tag that shows it is “labor cost”. Attaching a tag like this can not only provide information necessary for each estimation item to a contractor but also make known a reason why an estimate is required. Then, information necessary for an estimate (any information out of the point group data, the 3D design information, and the generated information) is transmitted to the plurality of contractor side terminals.

In S2030, the contractee side terminal outputs the point group data and the 3D design information from the design drawing. Furthermore, an estimate format showing types and a quantity of parts is outputted. In this regard, the estimate format can be changed according to the content to be requested to a building contractor. For example, for a work consisting of three processes, an estimate for only a first process may be requested to a building contractor A while an estimate for all of the first to third processes may be requested collectively to a building contractor. In this way, the contractee can finally select (one or more) building contractors in an efficient manner.

In S2040, based on the tag, each of the plurality of contractor side terminals displays types and a quantity of parts and displays a work item necessary for construction.

In S2050, each of the plurality of contractor side terminals prompts input of data with respect to a unit price for each type of the parts and input of data with respect to a unit price and workload required for the work item and transmits inputted data to the server. As an estimation item can be generated based on the tag, when an estimate is created for each process, for example, parts or labor cost required for each process can be estimated.

In S2060, the server or the plurality of contractor side terminals calculate an estimated cost based on the obtained data. It should be noted that when the plurality of contractor side terminals calculate estimated costs, the plurality of contractor side terminals transmit the estimated costs to the server.

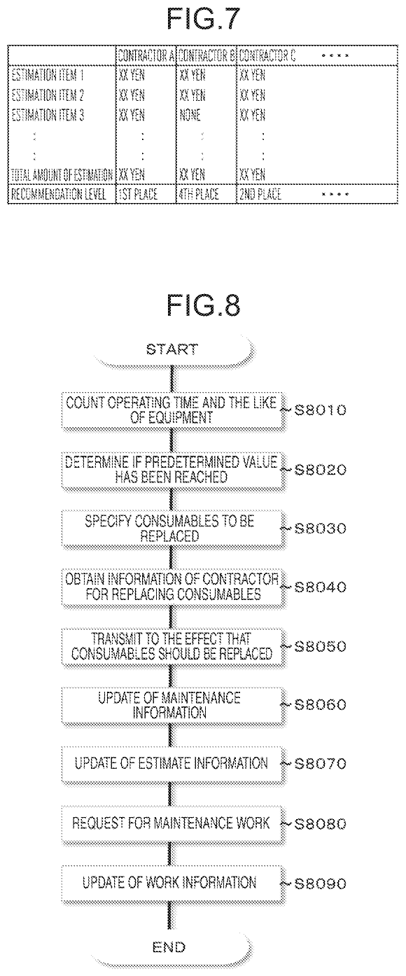

In S2070, the server presents the estimated costs transmitted from the plurality of contractor side terminals to the contractee side terminal. One example of estimate comparison is shown in FIG. 7.

In S2080, the contractee side terminal selects any one of the estimated costs.

In S2090, the server transmits a selected result to the plurality of contractor side terminals.

Next, the flowchart of information disclosure that generates a data structure will be described.

In S2110, a name of a data structure is decided. It may be configured in such a way that a user can arbitrarily change a name after the system has automatically allocated the tentative name composed randomly of alphabets and numbers.

In S2120, a table corresponding to the name is generated in a database. In this regard, one example of a table to be generated is shown in FIG. 4.

In S2130, coordinates in a factory are determined from the point group data.

In S2140, the 3D design information is associated and stored in the database.

In S2150, a parts and work item is associated and stored in the database.

In S2160, the contractee and the estimate information are associated and stored.

By applying this embodiment, a maintenance information recording service can be provided. The maintenance information recording service allows a maintenance person to execute a maintenance work in a site while carrying a tablet computer, which enables consistent check quality due to an instruction given by the system as to a place to be checked and/or a viewpoint to be considered while checking. Additionally, an unfalsifiable check record using GPS and photos is recorded as digital data.

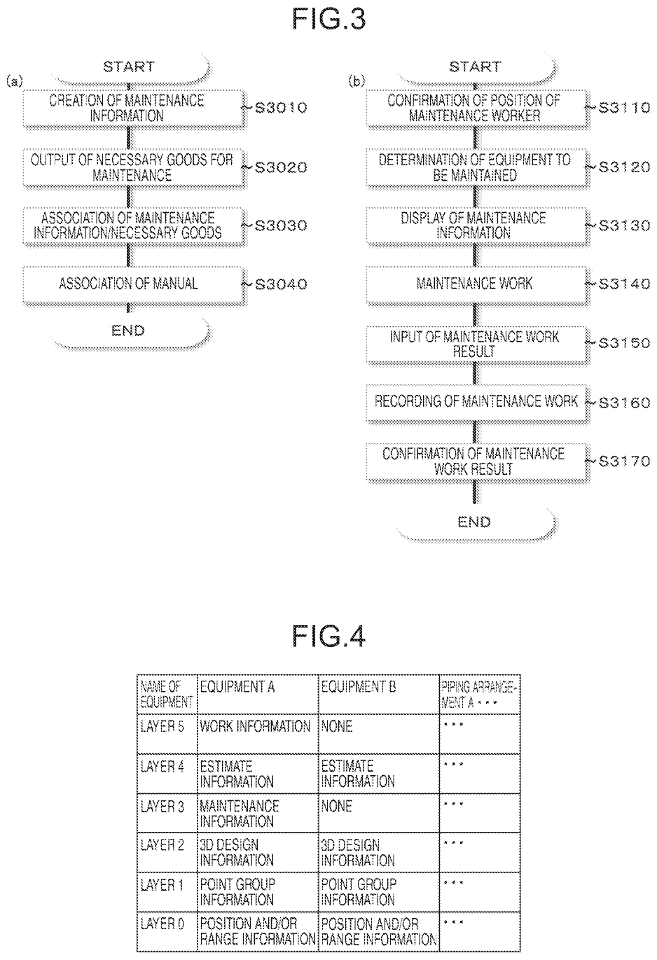

FIGS. 3A and 3B show each an example of information processing in the system according to one embodiment of the present invention. They are each an example of information processing to three-dimensionally execute a maintenance information system in a factory.

FIG. 3A is an example of information processing with respect to generation of maintenance information.

In S3010, a format for recording the maintenance information is generated from design information.

In S3020, types and a quantity of parts necessary for maintenance are determined based on the maintenance information.

In S3030, the maintenance information and the types and the quantity of the parts necessary for maintenance are associated with the coordinates of the 3D design information and stored in a table as shown in FIG. 4.

In S3040, a manual with respect to a maintenance method of equipment (maintenance work procedures) and the like are associated with the coordinates and stored as the maintenance information.

FIG. 3B is an example of information processing with respect to update of maintenance information.

In S3110, position information of a maintenance worker is acquired by using means for determining position information such as GPS.

In S3120, based on the position information of the maintenance worker, equipment that is located closest to the position of the maintenance worker is determined (by arbitrary selection of the worker if more than one pieces of equipment are suggested for maintenance) as the one to be maintained. The maintenance person confirms the equipment assigned for maintenance, and starts a maintenance work mode by tapping a work start button.

In S3130, part or all of maintenance information of the equipment to be maintained (such as maintenance work procedures and equipment information) are displayed on a maintenance terminal carried by the maintenance worker.

In S3140, the maintenance person executes a maintenance work. At the request of the maintenance worker, the maintenance information is switched to a necessary piece of information.

In S3150, the maintenance person inputs a maintenance work result at the completion of the maintenance work. The maintenance work result described here indicates whether or not the maintenance work has been completed in a normal manner as well as types and a quantity of replaced parts.

In S3160, the maintenance person takes a photo of a record of the maintenance work using the maintenance terminal at the completion of the work. In this regard, if the photo taken includes information of EXIF (Exchangeable image file format), the maintenance person extracts position information (GPS information) to confirm a work position of the worker, and confirms whether or not the photo has been taken in a position within a predetermined range with reference to the equipment to which the maintenance work was executed. In this way, falsification or the like of the photo can be prevented.

In S3170, upon confirming that the maintenance information has been updated in S3150 and S3160 and that no error has occurred in the updated information, the maintenance work mode is terminated.

In another embodiment, if the position information of the maintenance person can be confirmed in S3160, S3110 may be omitted. In this case, in S3120, equipment may be displayed on the maintenance terminal carried by the maintenance worker so that the equipment to be maintained can be arbitrarily selected. The maintenance work mode may start when the maintenance worker selects the equipment to be maintained.

FIG. 4 is an example of a data structure used in the system according to one embodiment of the present invention.

The data structure according to the embodiment is based on 3D point group data.

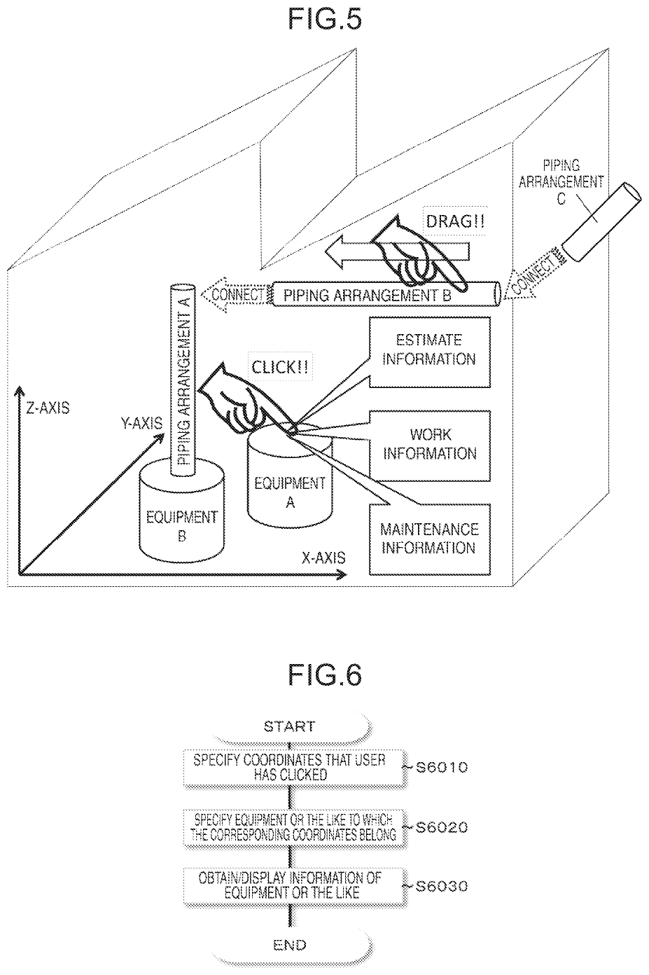

FIG. 5 is an example of a work drawing displayed on a display screen of the system according to one embodiment of the present invention.

The work drawing according to the embodiment shows an outer appearance of a factory represented in a three-dimensional format. Furthermore, equipment A and equipment B are arranged inside the factory. In this regard, the equipment A and the equipment B are assumed to be arranged in the factory in reality, and denote point group data obtained by 3D scanning in the factory by using a 3D scanner (not shown) or the like. Then, the obtained point group data is associated with coordinates (x, y, z) in and unique to each factory. For example, it is assumed that the point group data of the equipment A is within the range of a cuboid from (10, 10, 0) to (20, 20, 50). In this regard, an arbitrary technique may be used to determine such a range.

FIG. 5 will be described hereinafter on the assumption that a user is considering adding a piping arrangement to the equipment B. To begin with, in FIG. 5, a piping arrangement A has already been arranged on the equipment B. Then, the user is attempting to drag a piping arrangement B to connect it to the piping arrangement A with the use of an input device such as a mouse. By performing such a work on a work drawing, various settings in a factory can be performed. Additionally, in the piping arrangement A and the piping arrangement B, respective thickness or length thereof may be modified by operating the input device such as the mouse or a keyboard.

When a work on the work drawing such as connection between the piping arrangement A and the piping arrangement B is completed, necessary information is generated based on information on the work drawing with respect to the piping arrangement A and the piping arrangement B. For example, based on a length and a thickness of a piping arrangement, types and a quantity of parts necessary to create the piping arrangement are calculated and outputted. Furthermore, when the piping arrangement A and the piping arrangement B are connected on the work drawing, a pop-up may be displayed that enables selection of a connecting apparatus (not shown) for connecting the piping arrangement A and the piping arrangement B. Additionally, types and a quantity of parts necessary to connect the piping arrangement A and the piping arrangement B may be automatically calculated and outputted.

In parallel with the above-described design work, or while executing another work, it may be desired to have information on the equipment A or the equipment B. In such a case, with a click on any point of the equipment A or the equipment B, one or more pieces of information with respect to the clicked equipment such as estimate information, work information, and maintenance information are displayed in a form similar to a pop-up. Specific processing will be described in FIG. 6.

The estimate information described here stands for information in which cost and the like that will be required in newly constructing or adding equipment or a piping arrangement are recorded. The work information described here stands for information in which an amount of time using equipment or the like as well as a work content are recorded. The maintenance information described here stands for information in which information necessary to maintain equipment is recorded, including information on types of parts replaced for the equipment, maintenance date, a contractor who has executed replacement, and a person in charge of supervision. Additionally, it may include information in which position information and photos are combined and recorded to specify the equipment to be maintained.

By applying this embodiment, a facility maintenance service using a cloud-service can be provided. The facility maintenance service according to the embodiment allows conformation of accurate information without visiting a site by confirming a condition and a maintenance status (such as a repair history and a maintenance history) of a facility in and outside of the site (a facility in which the factory side terminal 400 in FIG. 1 is installed) from the contractee side terminal 300 in FIG. 1 in a virtual space through the Internet. For example, physical information such as a length of a pipe or a width of a road can be managed.

An operation according to the embodiment will be described with reference to a flowchart in FIG. 6.

In S6010, a user clicks any point on a work drawing. In FIG. 5, the user is clicking the equipment A arranged in a factory and displayed virtually on a work drawing. The present system calculates (in-factory) coordinates (x, y, z) corresponding to the clicked point for specification. It should be noted that since the coordinates in a factory displayed virtually (virtual coordinates) are different from the actual coordinates on a work drawing (real coordinates), a correspondence table between the virtual coordinates and the real coordinates (not shown) may be prestored in any storage table of the present system.

In S6020, with regard to the specified coordinates, by referring to a table as shown in Layer 0 of FIG. 4, equipment or a piping arrangement to which the corresponding coordinates belong is searched for. In this embodiment, as a point where point group data of the equipment A is present is clicked by the user, the system according to the embodiment determines that the equipment A has been selected.

In S6030, one or more pieces of information corresponding to the equipment A (such as the estimate information, the work information, and the maintenance information in the example of FIG. 5) are read from the database and displayed on the display screen.

By applying this embodiment, an ordering support service using a cloud-service can be provided. The ordering support service of this embodiment supports a contractee in deciding to which building contractor a construction should be requested by allowing the business entity of the contractee (an establishment in which the contractee side terminal 200 is installed) to disclose a construction request for repair and/or improvement in a site and by allowing the building contractors (establishments in each of which the contractor side terminal 100 in FIG. 1 is installed) who have seen the information to submit their respective estimates.

FIG. 7 is an example of estimate comparison according to the embodiment.

In the embodiment, as shown in FIG. 7, a comparison table is created and displayed that is classified for each of the contractor side terminals and for each of the work items. Using this table, a case is assumed, for example, where an extremely cheap (or extremely expensive) item (a field indicating “none” in FIG. 7) is found while checking estimation items of a certain contractor. Since such case is often associated with estimation mistakes, re-estimate of an entire estimate or of a corresponding estimation item may be requested from the contractee side terminal to the corresponding contractor side terminal. Specifically, for example, if there is an item for which an estimated price exceeding a predetermined range (e.g., within 2σ of a predetermined deviation), which is obtained based on the average of the estimated prices for each item transmitted from each contractor side terminal, the item (a field indicating “none” in FIG. 7) may be shaded in a visually different color (e.g., red) to inform the contractor side terminal of a request to reconsider the estimate in an automatic manner.

Furthermore, in the embodiment, the estimation items can be rearranged and recalculated so that the estimates can be compared and examined from a different perspective. For example, it is assumed that the estimation items are set for each work process. If a user wishes to compare and examine the estimates from a different perspective (which may be, for example, a perspective from a total amount of parts cost or a total amount of labor cost, or may be a perspective from a unit price or a working time), by clicking such a button on the work drawing (not shown), the system according to the embodiment recalculates and redisplays the estimates.

In addition, in the embodiment, after displaying in the form of a list the final version of estimates transmitted from the respective contractor side terminals, in order to support in deciding to which contractor an order should be requested (by transmitting signals to a contractor side terminal to the effect that its ordering has been approved), for example, estimated costs may be sorted in descending order, or a particular estimation item may be weighted (prioritized) (by an input or the like from the contractee side terminal) for sorting in descending order of recommendation.

In addition, by applying this embodiment, a maintenance service combined with a production management service using a cloud-service can be provided. In a facility of a factory, there is a certain relationship between maintenance management and production management. For example, in one facility, when a predetermined number of products are manufactured, consumables in the facility may need to be replaced. Also, in another facility, when an operating time has exceeded a predetermined time, consumables in the facility may need to be replaced. If these conditions of individual facilities are preset, and when a corresponding set value has been reached, that information can be transmitted to the contractee side terminal and the contractor side terminals. This will enable an integrated service of production management and maintenance management to be provided.

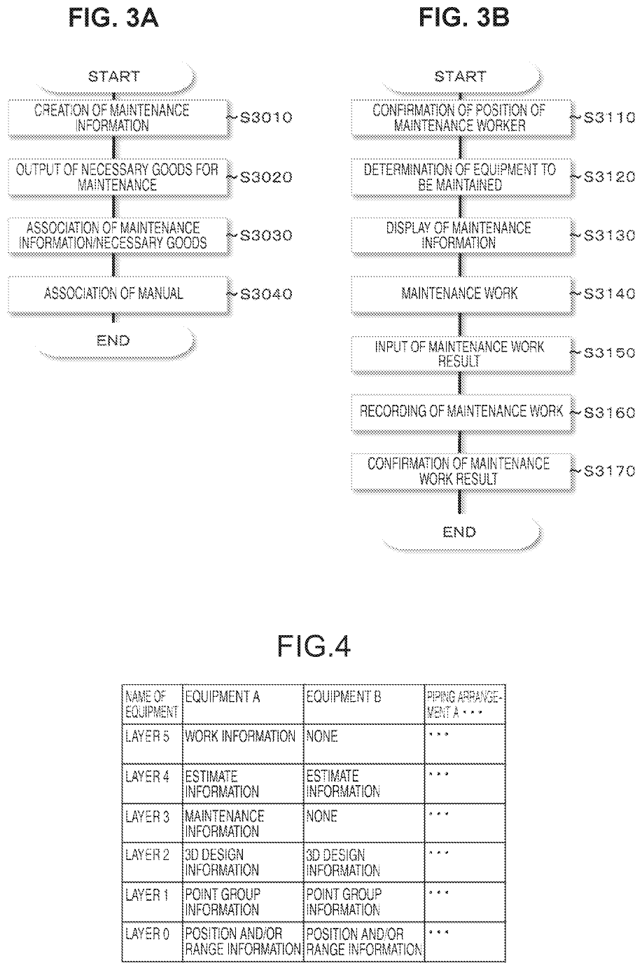

FIG. 8 is an example of information processing with respect to a maintenance management service combined with a production management service.

In S8010, an operating time of a facility and a production volume of a product are counted.

In S8020, whether or not the facility has reached a preset value (such as the operating time or the production volume) is determined. It should be noted that there may be a plurality of preset values.

In S8030, consumables to be replaced are read out from the maintenance information in FIG. 4 when the preset value has been reached.

In S8040, a contractor with respect to the consumables is acquired from the maintenance information in FIG. 4.

In S8050, signals are transmitted to the contractee side terminal and the contractor side terminals to the effect that consumables should be replaced.

In S8060, a time when the consumables are replaced and a time when a notification is given to the contractor side terminals and the like are recorded (updated) in the maintenance information of FIG. 4.

In S8070, when the contractor side terminals notify the contractee of estimate information with respect to consumable replacement, the estimate information is recorded (updated) in the estimate information of FIG. 4.

In S8080, when the contractee side terminal approves an estimate in S8070, a notification of approval is transmitted to the contractor side terminal. If the estimate is not approved, or if the order is to be placed to another contractor, the step may return to S8070.

In S8090, when a consumable replacement work on a contractor side is completed, a contractor that has executed the consumable replacement work, a work completion time and the like are recorded in the work information in FIG. 4.

In another embodiment, the system may be configured in such a manner that when a preset value has been reached in and after S8030, signals are transmitted to the contractor side terminals and the contractee side terminal to the effect that a periodic inspection is necessary for the facility.

Having thus described the embodiments of the invention, based on the above description, to those skilled in the art, various alternatives, modifications or variations are possible, and the present invention is intended to cover various alternatives, modifications or variations described above without departing from the scope thereof.

1. A system in which a contractee side terminal, a server, and a plurality of contractor side terminals are connected through a network, the system comprising:
means, in the contractee side terminal, for drawing a facility or a piping arrangement of a building on a design drawing,
means, in the contractee side terminal, for outputting point group data and 3D design information from the design drawing,
means, in the server, for outputting the point group data from the design drawing as well as types and a quantity of parts from the 3D design information,
means, in each of the plurality of contractor side terminals, for displaying the types and the quantity of the parts and to display a work item necessary for construction,
means, in each of the plurality of contractor side terminals, for prompting input of data with respect to a unit price for each type of the parts and input of data with respect to a unit price and workload required for the work item and transmitting inputted data to the server,
means, in the server, for calculating an estimated cost based on data obtained from the input means,
means, in the server, for presenting estimated costs transmitted from the plurality of contractor side terminals to the contractee side terminal,
means, in the contractee side terminal, for selecting any one of the estimated costs, and
means, in the server, for transmitting a selected result to the plurality of contractor side terminals.

2. The system according to claim 1, comprising
means for generating maintenance information from the 3D design information, and
means for determining types and a quantity of parts necessary for maintenance based on the maintenance information, wherein
the 3D design information and the maintenance information are associated with point group data and stored.

3. The system according to claim 1, wherein the means for presenting the estimated costs presents a comparison table classified for each of the contractor side terminals and each of the work items.
